(19) United States
(12) Patent Application Publication
(10) Pub. No.: US 2005/0250497 A1
(43) Pub. Date: Nov. 10, 2005

(54) Acknowledgement method for ACK/NACK signaling to facilitate UE uplink data transfer

(76) Inventors: Amitava Ghosh, Buffalo Grove, IL (US); Tyler A. Brown, Mundelein, IL (US); Robert T. Love, Barrington, IL (US); Rapeepat Ratasuk, Hoffman Estates, IL (US); Weimin Xiao, Barrington, IL (US)

Correspondence Address: MOTOROLA, INC., 1303 EAST ALGONQUIN ROAD, IL01/3RD, SCHAUMBURG, IL, 60196, US

(21) Appl. No.: 11/080,789

(22) Filed: Mar. 15, 2005

Related U.S. Application Data
(60) Provisional application No. 60/568,291, filed on May 5, 2004.

(51) Int. Cl. H04Q 7/20

(52) U.S. Cl. 455/436; 455/439

(57) ABSTRACT

To address the need to convey ACK/NACK information in a manner that conserves system and signaling resources, embodiments of the present invention employ a Node-B transmitting on two types of ACK/NACK broadcast channels (501, 502), one type for received uplink data that was scheduled by the Node B and the other type of broadcast channel for received uplink data that was not scheduled by the Node B. Other embodiments of the invention employ a Node-B transmitting on two types of broadcast channels, one type of broadcast channel for received uplink data that comes from non-SHO users and another type of broadcast channel for received uplink data that comes from non-scheduled users or comes from scheduled SHO users. In addition, ACK/NACK information is scheduled (800) into the available broadcast channel time slots in accordance with a transmission priority that is determined by a scheduler.

### REFERENCE(S) TO RELATED APPLICATION(S)

The present application claims priority from provisional application Ser. No. 60/568,291, entitled “METHOD FOR ACK/NACK SIGNALING TO FACILITATE UE UPLINK DATA TRANSFER,” filed May 5, 2004, which is commonly owned and incorporated herein by reference in its entirety.

This application is related to a co-pending application entitled “METHOD FOR RATE CONTROL SIGNALING TO FACILITATE UE UPLINK DATA TRANSFER,” filed on even date herewith, assigned to the assignee of the present application, and hereby incorporated by reference.

This application is related to a co-pending application Ser. No. 10/427,120, entitled “HARQ ACK/NAK CODING FOR A COMMUNICATION DEVICE DURING SOFT HANDOFF,” filed Apr. 30, 2003, which is assigned to the assignee of the present application.

This application is related to a co-pending application Ser. No. 10/695,513, entitled “METHOD AND APPARATUS FOR PROVIDING A DISTRIBUTED (ARCHITECTURE DIGITAL WIRELESS COMMUNICATION SYSTEM,” filed Oct. 28, 2003, which is assigned to the assignee of the present application.

### FIELD OF THE INVENTION

The present invention relates generally to wireless communication systems and, in particular, to ACK/NACK signaling to facilitate UE uplink data transfer.

### BACKGROUND OF THE INVENTION

In a Universal Mobile Telecommunications System (UMTS), such as that proposed for the next of the third generation partnership project (3GPP) standards for the UMTS Terrestrial Radio Access Network (UTRAN), such as wideband code division multiple access (WCDMA) or cdma2000 for example, user equipment (UE) such as a mobile station (MS) communicates with any one or more of a plurality of base station subsystems (BSSs) dispersed in a geographic region. Typically, a BSS (known as Node-B in WCDMA) services a coverage area that is divided up into multiple sectors (known as cells in WCDMA). In turn, each sector is serviced by one or more of multiple base transceiver stations (BTSs) included in the BSS. The mobile station is typically a cellular communication device. Each BTS continuously transmits a downlink pilot signal. The MS monitors the pilots and measures the received energy of the pilot symbols.

In a typical cellular system, there are a number of states and channels for communications between the MS and the BSS. For example, in IS95, in the Mobile Station Control on the Traffic State, the BSS communicates with the MS over a Forward Traffic Channel in a forward link and the MS communicates with the BSS over a Reverse Traffic Channel in a reverse link. During a call, the MS must constantly monitor and maintain four sets of pilots. The four sets of pilots are collectively referred to as the Pilot Set and include an Active Set, a Candidate Set, a Neighbor Set, and a Remaining Set, where, although the terminology may differ, the same concepts generally apply to the WCDMA system.

The Active Set includes pilots associated with the Forward Traffic Channel assigned to the MS. This set is active in that the pilots and companion data symbols associated with this set are all actively combined and demodulated by the MS. The Candidate Set includes pilots that are not currently in the Active Set but have been received by the MS with sufficient strength to indicate that an associated Forward Traffic Channel could be successfully demodulated. The Neighbor Set includes pilots that are not currently in the Active Set or Candidate Set but are likely candidates for handoff. The Remaining Set includes all possible pilots in the current system on the current frequency assignment, excluding the pilots in the Neighbor Set, the Candidate Set, and the Active Set.

When the MS is serviced by a first BTS, the MS constantly searches pilot channels of neighboring BTSs for a pilot that is sufficiently stronger than a threshold value. The MS signals this event to the first, serving BTS using a Pilot Strength Measurement Message. As the MS moves from a first sector serviced by a first BTS to a second sector serviced by a second BTS, the communication system promotes certain pilots from the Candidate Set to the Active Set and from the Neighbor Set to the Candidate Set. The serving BTS notifies the MS of the promotions via a Handoff Direction Message. Afterwards, for the MS to commence communication with a new BTS that has been added to the Active Set before terminating communications with an old BTS, a “soft handoff” will occur.

For the reverse link, typically each BTS in the Active Set independently demodulates and decodes each frame or packet received from the MS. It is then up to a switching center or selection distribution unit (SDU) normally located in a Base Station Site Controller (BSC), which is also known as a Radio Network Controller (RNC) in WCDMA terminology, to arbitrate between the each BTS's decoded frames. Such soft handoff operation has multiple advantages. Qualitatively, this feature improves and renders more reliable handoff between BTSs as a user moves from one sector to the adjacent one. Quantitatively soft-handoff improves the capacity/coverage in a cellular system. However, with the increasing amount of demand for data transfer (bandwidth), problems can arise.

Several third generation standards have emerged, which attempt to accommodate the anticipated demands for increasing data rates. At least some of these standards support synchronous communications between the system elements, while at least some of the other standards support asynchronous communications. At least one example of a standard that supports synchronous communications includes cdma2000. At least one example of a standard that supports asynchronous communications includes WCDMA.

While systems supporting synchronous communications can sometimes allow for reduced search times for handover searching and improved availability and reduced time for position location calculations, systems supporting synchronous communications generally require that the base stations be time synchronized. One such common method employed for synchronizing base stations includes the use of global positioning system (GPS) receivers, which are co-located with the base stations that rely upon line of sight transmissions between the base station and one or more satellites located in orbit around the earth. However, because line of sight transmissions are not always possible for base stations that might be located within buildings or tunnels, or base stations that may be located under the ground, sometimes the time synchronization of the base stations is not always readily accommodated.

However, asynchronous transmissions are not without their own set of concerns. For example, the timing of uplink transmissions in an environment supporting MS-autonomous scheduling (whereby a MS may transmit whenever the MS has data in its transmit buffer and all MSs are allowed to transmit as needed) by the individual MSs can be quite sporadic and/or random in nature. While traffic volume is low, the autonomous scheduling of uplink transmissions is less of a concern, because the likelihood of a collision (i.e. overlap) of data being simultaneously transmitted by multiple MSs is also low. Furthermore, in the event of a collision, there are spare radio resources available to accommodate the need for any retransmissions. However, as traffic volume increases, the likelihood of data collisions (overlap) also increases. The need for any retransmissions also correspondingly increases, and the availability of spare radio resources to support the increased amount of retransmissions correspondingly diminish. Consequently, the introduction of explicit scheduling (whereby a MS is directed by the network when to transmit) by a scheduling controller can be beneficial.

However even with explicit scheduling, given the disparity of start and stop times of asynchronous communications and more particularly the disparity in start and stop times relative to the start and stop times of different uplink transmission segments for each of the non-synchronized base stations, gaps and overlaps can still occur. Both data gaps and overlaps represent inefficiencies in the management of radio resources (such as rise over thermal (ROT), a classic and well-known measure of reverse link traffic loading in CDMA systems), which if managed more precisely can lead to more efficient usage of the available radio resources and a reduction in the rise over thermal (ROT).

For example, FIG. 1 is a block diagram of communication system 100 of the prior art. Communication system 100 can be a cdma2000 or a WCDMA system. Communication system 100 includes multiple cells (seven shown), wherein each cell is divided into three sectors (a, b, and c). A BSS 101-107 located in each cell provides communications service to each mobile station located in that cell. Each BSS 101-107 includes multiple BTSs, which BTSs wirelessly interface with the mobile stations located in the sectors of the cell serviced by the BSS. Communication system 100 further includes a radio network controller (RNC) 110 coupled to each BSS and a gateway 112 coupled to the RNC. Gateway 112 provides an interface for communication system 100 with an external network such as a Public Switched Telephone Network (PSTN) or the Internet.

The quality of a communication link between an MS, such as MS 114, and the BSS servicing the MS, such as BSS 101, typically varies over time and movement by the MS. As a result, as the communication link between MS 114 and BSS 101 degrades, communication system 100 provides a soft handoff (SHO) procedure by which MS 114 can be handed off from a first communication link whose quality has degraded to another, higher quality communication link. For example, as depicted in FIG. 1, MS 114, which is serviced by a BTS servicing sector b of cell 1, is in a 3-way soft handoff with sector c of cell 3 and sector a of cell 4. The BTSs associated with the sectors concurrently servicing the MS, that is, the BTSs associated with sectors 1-b, 3-c, and 4-a, are known in the art as the Active Set of the MS.

Referring now to FIG. 2, a soft handoff procedure performed by communication system 100 is illustrated. FIG. 2 is a block diagram of a hierarchical structure of communication system 100. As depicted in FIG. 2, RNC 110 includes an ARQ function 210, a scheduler 212, and a soft handoff (SHO) function 214. FIG. 2 further depicts multiple BTSs 201-207, wherein each BTS provides a wireless interface between a corresponding BSS 101-107 and the MSs located in a sector serviced by the BSS.

When performing a soft handoff, each BTS 201, 203, 204 in the Active Set of the MS 114 receives a transmission from MS 114 over a reverse link of a respective communication channel 221, 223, 224. The Active Set BTSs 201, 203, and 204 are determined by SHO function 214. Upon receiving the transmission from MS 114, each Active Set BTS 201, 203, 204 demodulates and decodes the contents of a received radio frame along with related frame quality information.

At this point, each Active Set BTS 201, 203, 204 then conveys the demodulated and decoded radio frame to RNC 110, along with related frame quality information. RNC 110 receives the demodulated and decoded radio frames along with related frame quality information from each BTS 201, 203, 204 in the Active Set and selects a best frame based on frame quality information. Scheduler 212 and ARQ function 210 of RNC 110 then generate control channel information that is distributed as identical pre-formatted radio frames to each BTS 201, 203, 204 in the Active Set. The Active Set BTSs 201, 203, 204 then simulcast the pre-formatted radio frames over the forward link. The control channel information is then used by MS 114 to determine what transmission rate to use.

Alternatively, the BTS of the current cell where the MS is camped (BTS 201) can include its own scheduler and bypass the RNC 110 when providing scheduling information to the MS. In this way, scheduling functions are distributed by allowing a mobile station (MS) to signal control information corresponding to an enhanced reverse link transmission to active set base transceiver stations (BTSs) and by allowing the BTSs to perform control functions that were previously supported by a RNC. The MS in a SHO region can choose a scheduling assignment corresponding to a best Transport Format and Resource Indicator (TFRI) out of multiple scheduling assignments that the MS receives from multiple Active Set BTS. As a result, the enhanced uplink channel can be scheduled during SHO, without any explicit communication between the BTSs. In either case, explicit transmit power constraints (which are implicit data rate constraints) are provided by a scheduler, which are used by the MS 114, along with control channel information, to determine what transmission rate to use.

As proposed for the UMTS system, a MS can use an enhanced uplink dedicated transport channel (EUDCH) to achieve an increased uplink data rate and to increase the sector and user throughput of the uplink. The MS must determine the data rate to use for the enhanced uplink based on local measurements at the MS and information provided by the scheduler or UTRAN. Moreover, to achieve higher throughput on the reverse link, communication systems such as communication system 100 have adapted techniques such as Hybrid Automatic Repeat ReQuest (H-ARQ) and Adaptive Modulation and Coding (AMC), as are known in the art.

Adaptive Modulation and Coding (AMC) provides the flexibility to match the modulation and forward error correction (FEC) coding scheme to the current channel conditions for each user, or MS, serviced by the communication system. AMC promises a large increase in average data rate for users that have a favorable channel quality due to their proximity to a BTS or other geographical advantage. Release-5 and Release-6 WCDMA systems with HSDPA and Enhanced Uplink can improve the capacity and user experience over Release-99 WCDMA through techniques like AMC, HARQ, Node-B based scheduling, etc. by 3-4 times for downlink and approximately 2 times over uplink.

AMC has several drawbacks such as sensitivity to channel quality measurement error and delay. More precisely, in order to select the appropriate modulation, the scheduler, such as scheduler 212, must be aware of the channel quality. Errors in the channel estimate will cause the scheduler to select the wrong data rate and either transmit at too high a power level, wasting system capacity, or too low a power level, raising the block error rate. Delay in reporting channel measurements also reduces the reliability of the channel quality estimate due to constantly varying mobile channel. To overcome measurement delay, the frequency of channel measurement reporting may be increased. However, an increase in measurement report rate consumes system capacity that otherwise might be used to carry data.

Hybrid ARQ is an implicit link adaptation technique. Whereas, in AMC explicit C/I measurements or similar measurements are used to set the modulation and coding format, in H-ARQ, link layer acknowledgements are used for re-transmission decisions. Many techniques have been developed for implementing H-ARQ, such as Chase combining, Rate Compatible Punctured Turbo codes, and Incremental Redundancy. Incremental Redundancy, or H-ARQ-type-II, is an implementation of the H-ARQ technique wherein instead of sending simple repeats of the entire coded packet, additional redundant information is incrementally transmitted if the decoding fails on the first attempt.

H-ARQ-type-III also belongs to the class of Incremental Redundancy ARQ schemes. However, with H-ARQ-type-III, each retransmission is self-decodable, which is not the case with H-ARQ-type II. Chase combining (also called H-ARQ-type-III with one redundancy version) involves the retransmission by the transmitter of the same coded data packet. The decoder at the receiver combines these multiple copies of the transmitted packet weighted by the received SNR. Diversity (temporal) gain as well as coding gain (for IR only) is thus obtained after each re-transmission. In H-ARQ-type-III with multiple redundancy, different puncture bits are used in each retransmission. The details for how to implement the various H-ARQ schemes are commonly known in the art and therefore are not discussed herein.

H-ARQ combined with AMC can greatly increase user throughputs, potentially doubling or even trebling system capacity. In effect, Hybrid ARQ adapts to the channel by sending additional increments of codeword redundancy, which increases the coding rate and effectively lowers the data rate to match the channel. Hybrid ARQ does not rely only on channel estimates but also relies on the errors signaled by the ARQ protocol. Node B controlled HARQ allows for rapid retransmissions of erroneously received data packets between the mobile station and Node-B. In both cdma2000 and WCDMA systems, the reverse link ARQ function, such as ARQ function 210, and a scheduling function, such as scheduling function 212, can reside in an RNC 110 or distributed within the BTSs, which can better support soft handoffs, avoiding latencies inherent when scheduling through the RNC.

A goal of Enhanced Uplink technology, which is currently being considered for standardization in 3GPP W-CDMA (Release-6), is to improve coverage, sector and user throughput of the current 3GPP UMTS uplink. Applications which can benefit from Enhanced Uplink technology include interactive gaming, file uploads and multimedia. The Enhanced Uplink will include advanced features such as AMC, HARQ, and fast scheduling of the UE by Node-B. To support HARQ for Enhanced Uplink and to allow rapid re-transmission, acknowledged/not acknowledged (ACK/NAK) feedback information from the BTSs to the uplink UE is needed. Moreover, it would be highly desirable to have methods for conveying such ACK/NACK information that conserve system and signaling resources.

### BRIEF DESCRIPTION OF THE DRAWINGS

FIG. 1 is a block diagram of an exemplary communication system of the prior art.

FIG. 2 is a block diagram of a hierarchical structure of the communication system of FIG. 1.

FIG. 3 depicts a distributed network architecture in accordance with multiple embodiments of the present invention.

FIG. 4 is a block diagram of a communication system in accordance with multiple embodiments of the present invention.

FIG. 5 is a block diagram representation of signaling on two ACK/NACK broadcast channels in accordance with multiple embodiments of the present invention.

FIG. 6 is an exemplary illustration of an ACK/NAK coloring for BPSK modulation, in accordance with multiple embodiments of the present invention.

FIG. 7 is an exemplary illustration of an ACK/NAK coloring for QPSK modulation, in accordance with multiple embodiments of the present invention.

FIG. 8 is a block diagram representation of prioritized ACK/NACK signaling in accordance with multiple embodiments of the present invention.

FIG. 9 is an exemplary illustration of ACK Code Channel Sets, in which scheduled users are assigned to ACK channel in scheduled user set or non-scheduled SHO user set (non-scheduled SHO users can only be assigned ACK channels in the non-scheduled SHO user set), in accordance with multiple embodiments of the present invention.

FIG. 10 is an exemplary illustration of a serial bit stream of a downlink physical channel, which is modulation mapped, spread, QPSK modulated and then scrambled, in accordance with multiple embodiments of the present invention.

FIG. 11 is an exemplary illustration of an ACK channel with 2 ms TTI in accordance with multiple embodiments of the present invention.

FIG. 12 is an exemplary illustration of SAM code channel sets, in which scheduled users are assigned to SAM channel in scheduled user set or poor coverage/non-scheduled SHO user set and in which non-scheduled SHO users can only be assigned SAM channels in the non-scheduled SHO user set, in accordance with multiple embodiments of the present invention.

FIG. 13 is an exemplary illustration of SAM code channel sets, given that SHO users can only be EU scheduled by one active set cell (same cell that is scheduling HS-PDSCH) until active set cell reselection occurs, in accordance with multiple embodiments of the present invention.

FIG. 14 is an exemplary illustration of a Scheduling Assignment Message channel in accordance with multiple embodiments of the present invention.

FIG. 15 is an exemplary illustration of SAM masking (color coding), encoding, and puncturing in accordance with multiple embodiments of the present invention.

FIG. 16 is an exemplary illustration of a FPCCH and a SPCCH in accordance with multiple embodiments of the present invention.

FIG. 17 is a table displaying exemplary characteristics of enhanced uplink channels in accordance with multiple embodiments of the present invention.

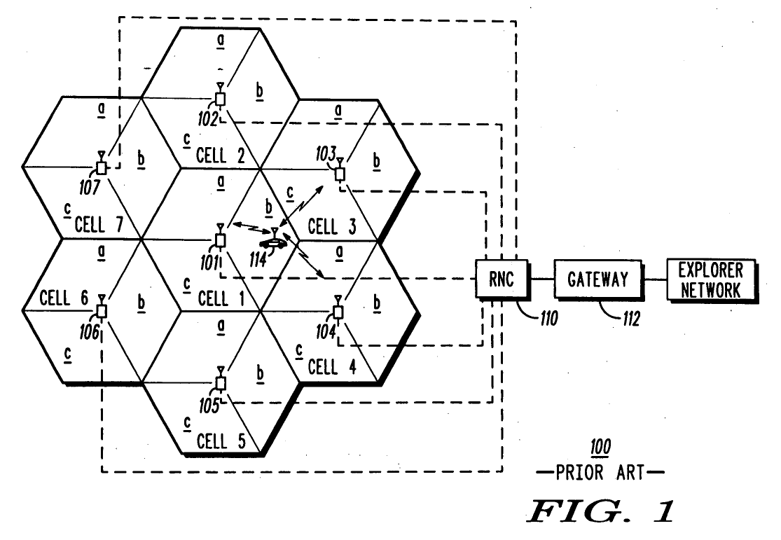

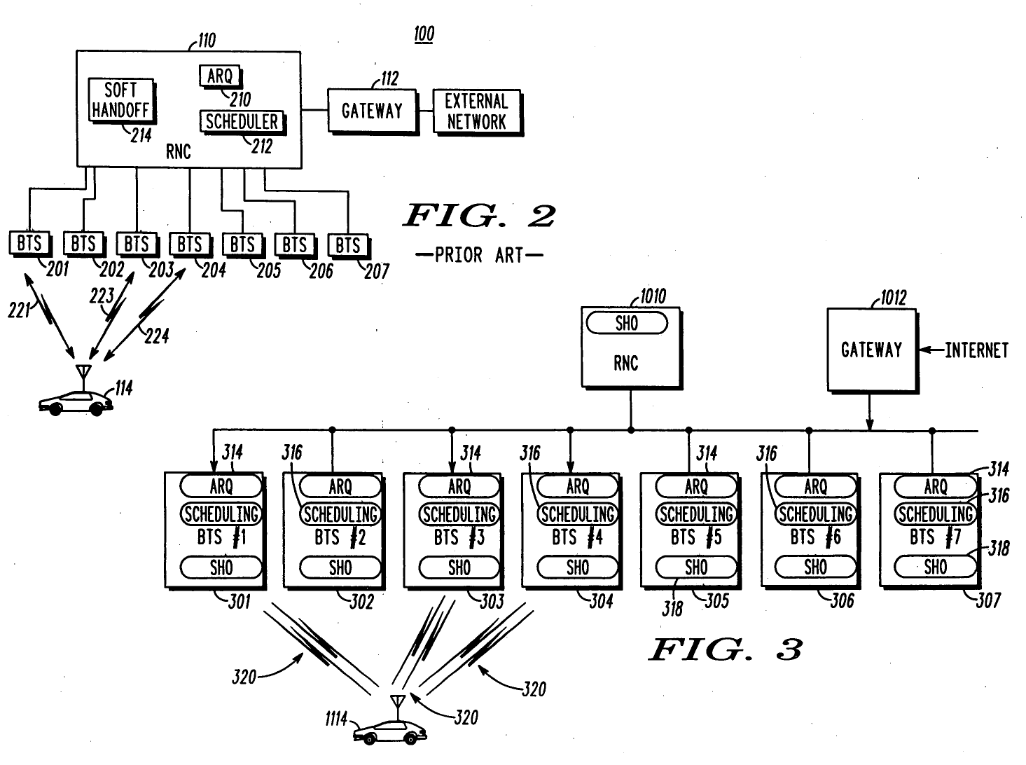

### DETAILED DESCRIPTION OF EMBODIMENTS

To address the need to convey ACK/NACK information in a manner that conserves system and signaling resources, embodiments of the present invention employ a Node-B transmitting on two types of ACK/NACK broadcast channels, one type for received uplink data that was scheduled by the Node B and the other type of broadcast channel for received uplink data that was not scheduled by the Node B. Other embodiments of the invention employ a Node-B transmitting on two types of broadcast channels, one type of broadcast channel for received uplink data that comes from non-SHO users and another type of broadcast channel for received uplink data that comes from non-scheduled users or comes from scheduled SHO users. In addition, ACK/NACK information is scheduled into the available broadcast channel time slots in accordance with a transmission priority that is determined by a scheduler. This enables high-priority users to transmit first and the scheduler intelligently manages the limited number of ACK/NACK transmission slots (especially for 2 ms TTI) that are available on the common ACK/NACK channels. Also, employing broadcast channels can conserve system code resources and reduce signaling overhead, as compared to implementations that do not employ ACK/NACK broadcast channels.

For example, alternative implementations employ dedicated radio resources per UE, instead of broadcast or common resources, on the forward-link to transmit H-ARQ acknowledgement information. As the number of mobiles grows in these implementations, valuable code resources are consumed and performance of the forward-link may be severely degraded. Furthermore, there is a large overhead required at the Node Bs to support dedicated acknowledgement channels for each UE.

Therefore, embodiments of the present invention convey acknowledgement information using broadcast channels, rather than dedicated resources. For example, some embodiments use Secondary Common Control Physical Channels (S-CCPCHs) for the ACK/NACK signaling. Moreover, among the multiple embodiments described are embodiments in which acknowledgment information to be transmitting during a transmission time interval (TTI) is prioritized, embodiments in which color coding of ACK/NACK information for UE uses a hashing function, embodiments in which the power of the ACK/NACK channels is dynamically adjusted, and embodiments in which adaptive ACK/NACK repetition coding is used to adjust the number of acknowledgements in response to TTI limitations.

Embodiments of the present invention encompass a method for ACK/NACK signaling to facilitate uplink data transfer by user equipment (UE) in a wireless communication system. The method comprises transmitting, by a Node-B, code channel indicators for a first ACK/NACK broadcast channel and for a second ACK/NACK broadcast channel. The method also comprises determining a transmission priority for ACK/NACK information to be conveyed to individual UE in response to uplink data received from the UE and scheduling the ACK/NACK information onto ACK/NACK broadcast channel time slots according to the transmission priority determined. Additionally, the method comprises transmitting, by the Node-B, ACK/NACK signaling to convey the scheduled ACK/NACK information via the first ACK/NACK broadcast channel when the received uplink data was scheduled by the Node-B and transmitting, by the Node-B, ACK/NACK signaling to convey the scheduled ACK/NACK information via the second ACK/NACK broadcast channel when the received uplink data was not scheduled by the Node-B.

Embodiments of the present invention alternatively encompass a method that comprises transmitting, by the Node-B, ACK/NACK signaling to convey the scheduled ACK/NACK information via the first ACK/NACK broadcast channel when the received uplink data came from a non-SHO user and transmitting, by the Node-B, ACK/NACK signaling to convey the scheduled ACK/NACK information via the second ACK/NACK broadcast channel when the received uplink came from non-scheduled user or came from a scheduled SHO user.

Embodiments of the present invention alternatively encompass a method that comprises transmitting, by the Node-B, ACK/NACK signaling to convey the scheduled ACK/NACK information via the first ACK/NACK broadcast channel when the received uplink data came from a non-SHO user and transmitting, by the Node-B, ACK/NACK signaling to convey the scheduled ACK/ANCK information via the second ACK/NACK broadcast channel when the received uplink came from a SHO user.

Embodiments of the present invention encompass another method for ACK/NACK signaling to facilitate uplink data transfer by UE in a wireless communication system. The method comprises receiving, by UE, code channel indicators for a first ACK/NACK broadcast channel and for a second ACK/NACK broadcast channel and transmitting, by UE, uplink data. The method also comprises monitoring, by UE, ACK/NACK signaling for a color code of the UE, wherein the first ACK/NACK broadcast channel is monitored for ACK/NACK signaling in response to the uplink data transmission from a scheduling Node-B and the second ACK/NACK broadcast channel is monitored for ACK/NACK signaling in response to the uplink data transmission from a non-scheduling Node-B.

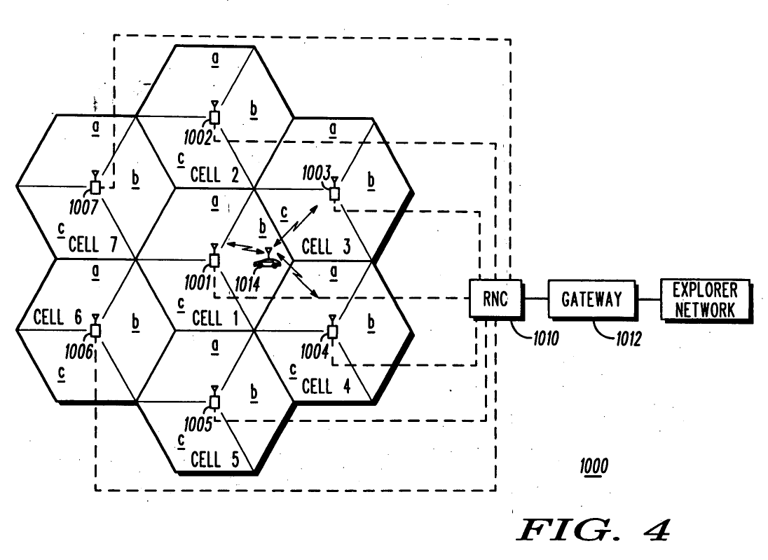

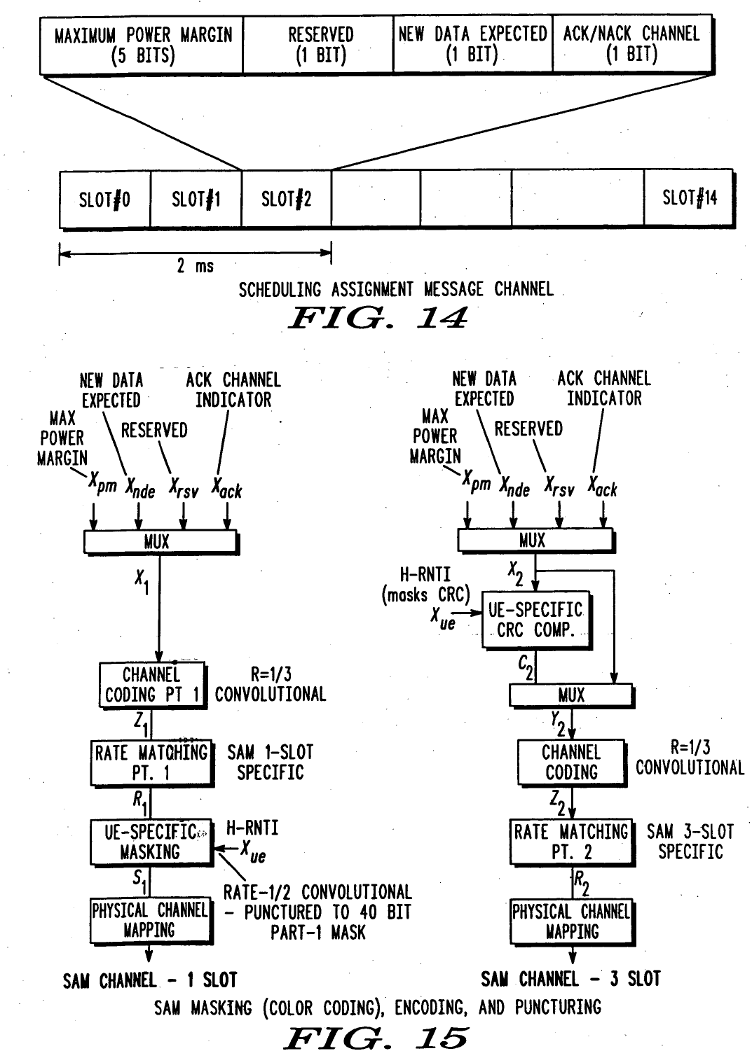

These and other embodiments of the present invention may be more fully described with reference to FIGS. 3-17. FIG. 4 is a block diagram of a communication system 1000 in accordance with multiple embodiments of the present invention. Preferably, communication system 1000 is a Code Division Multiple Access (CDMA) communication system, such as cdma2000 or Wideband CDMA (WCDMA) communication system, that includes multiple communication channels. Those who are of ordinary skill in the art realize that communication system 1000 may operate in accordance with any one of a variety of wireless communication systems, such as a Global System for Mobile communication (GSM) communication system, a Time Division Multiple Access (TDMA) communication system, a Frequency Division Multiple Access (FDMA) communication system, or an Orthogonal Frequency Division Multiple Access (OFDM) communication system.

Similar to communication system 100, communication system 1000 includes multiple cells (seven shown). Each cell is divided into multiple sectors (three shown for each cell—sectors a, b, and c). A base station subsystem (BSS) 1001-1007 located in each cell provides communications service to each mobile station located in that cell. Each BSS 1001-1007 includes multiple base stations, also referred to herein as base transceiver stations (BTSs), which wirelessly interface with the mobile stations located in the sectors of the cell serviced by the BSS. Communication system 1000 further includes a radio network controller (RNC) 1010 coupled to each BSS, preferably through a 3GPP TSG UTRAN lub Interface, and a gateway 1012 coupled to the RNC. Gateway 1012 provides an interface for communication system 1000 with an external network such as a Public Switched Telephone Network (PSTN) or the Internet.

Referring now to FIGS. 3 and 4, communication system 1000 further includes at least one mobile station (MS) 1014. MS 1014 may be any type of wireless user equipment (UE), such as a cellular telephone, a portable telephone, a radiotelephone, or a wireless modem associated with data terminal equipment (DTE) such as a personal computer (PC) or a laptop computer. Note that MS, UE, and user are used interchangeably throughout the following text. MS 1014 is serviced by multiple base stations, or BTSs, that are included in an Active Set associated with the MS. MS 1014 wirelessly communicates with each BTS in communication system 1000 via an air interface that includes a forward link (from the BTS to the MS) and a reverse link (from the MS to the BTS). Each forward link includes multiple forward link control channels, a paging channel, and traffic channel. Each reverse link includes multiple reverse link control channels, a paging channel, and a traffic channel. However, unlike communication system 100 of the prior art, each reverse link of communication system 1000 further includes another traffic channel, an Enhanced Uplink Dedicated Transport Channel (EUDCH), that facilitates high speed data transport by permitting a transmission of data that can be dynamically modulated and coded, and demodulated and decoded, on a sub-frame by sub-frame basis.

Communication system 1000 includes a soft handoff (SHO) procedure by which MS 1014 can be handed off from a first air interface whose quality has degraded to another, higher quality air interface. For example, as depicted in FIG. 4, MS 1014, which is serviced by a BTS servicing sector b of cell 1, is in a 3-way soft handoff with sector c of cell 3 and sector a of cell 4. The BTSs associated with the sectors concurrently servicing the MS, that is, the BTSs associated with sectors 1-b, 3-c, and 4-a, are the Active Set of the MS. In other words, MS 1014 is in soft handoff (SHO) with the BTSs 301, 303, and 304, associated with the sectors 1-b, 3-c, and 4-a servicing the MS, which BTSs are the Active Set of the MS. As used herein, the terms ‘Active Set’ and ‘serving,’ such as an Active Set BTS and a serving BTS, are interchangeable and both refer to a BTS that is in an Active Set of an associated MS. Furthermore, although FIGS. 3 and 4 depict BTSs 301, 303, and 304 as servicing only a single MS, those who are of ordinary skill in the art realize that each BTS 301-307 may concurrently schedule, and service, multiple MSs, that is, each BTS 301-307 may concurrently be a member of multiple Active Sets.

FIG. 3 depicts a network architecture 300 of communication system 1000 in accordance with multiple embodiments of the present invention. As depicted in FIG. 3, communication system 1000 includes multiple BTSs 301-307, wherein each BTS provides a wireless interface between a corresponding BSS 1001-1007 and the MSs located in a sector serviced by the BTS. Preferably, a scheduling function 316, an ARQ function 314 and a SHO function 318 are distributed in each of the BTSs 301-307. RNC 1010 is responsible for managing mobility by defining the members of the Active Set of each MS serviced by communication system 1000, such as MS 1014, and for coordinating multicast/multireceive groups. For each MS in communication system 1000, Internet Protocol (IP) packets are multi-cast directly to each BTS in the Active Set of the MS, that is, to BTSs 301, 303, 304 in the Active Set of MS 1014.

Preferably, each BTS 301-307 of communication system 1000 includes a SHO function 318 that performs at least a portion of the SHO functions. For example, SHO function 318 of each BTS 301, 303, 304 in the Active Set of the MS 1014 performs SHO functions such as frame selection and signaling of a new data indicator. Each BTS 301-307 can include a scheduler, or scheduling function, 316 that alternatively can reside in the RNC 110. With BTS scheduling, each Active Set BTS, such as BTSs 301, 303, and 304 with respect to MS 1014, can choose to schedule the associated MS 1014 without need for communication to other Active Set BTSs based on scheduling information signaled by the MS to the BTS and local interference and SNR information measured at the BTS. By distributing scheduling functions 306 to the BTSs 301-307, there is no need for Active Set handoffs of a EUDCH in communication system 1000. The ARQ function 314 and AMC function, which functionality also resides in RNC 110 of communication system 100, can also be distributed in BTSs 301-307 in communication system 1000. As a result, when a data block transmitted on a specific Hybrid ARQ channel has successfully been decoded by an Active Set BTS, the BTS acknowledges the successful decoding by conveying an ACK to the source MS (e.g. MS 1014) without waiting to be instructed to send the ACK by the RNC 1010.

In order to allow each Active Set BTS 301, 303, 304 to decode each EUDCH frame, MS 1014 conveys to each Active Set BTS, in association with the EUDCH frame, modulation and coding information, incremental redundancy version information, HARQ status information, and transport block size information from MS 1014, which information is collectively referred to as transport format and resource-related information (TFRI). The T-FRI only defines rate and modulation coding information and H-ARQ status. The MS 1014 codes the TFRI and sends the TFRI over the same frame interval as the EUDCH (accounting for the fact that the frame boundaries of the TFRI and EUDCH may be staggered).

For example, as is known in the art, during reverse link communications, the MS 1114 transmits frames to a plurality of BTSs 301, 303, 304. The structure of the frames, includes: (a) a flush or new data indicator bit which indicates to the BTS when to combine a current frame with a previously stored frame or to flush the current buffer; (b) data; (c) a cyclic redundancy check (CRC) bit which indicates whether a frame decoded successfully or not (i.e., whether the frame contained any errors); and (d) a tail bit for flushing the channel decoder memory. The received information contained in the frame is referred to herein as soft information. The BTSs can combine frames from multiple re-transmissions using an H-ARQ scheme.

After receiving a frame from the MS 1114, the BTSs 301, 303, 304 will process the frame and communicate to the MS 1114 over forward broadcast channels whether the frame contained any errors. If all BTSs communicate that the frame contains errors, the MS 1114 will retransmit the same frame to all BTSs, with the flush bit cleared to instruct the BTSs to combine the retransmitted frame with the original stored frame. If at least one of the BTSs communicates that the frame contains no errors, the MS 1114 will transmit the next frame to all the BTSs with the flush bit set to instruct all BTSs to erase the previous frame from memory and not to combine the previous frame with the current frame. Finally, as with respect to FIG. 3, the two sets of ACK/NAK broadcast channels 320 are described below.

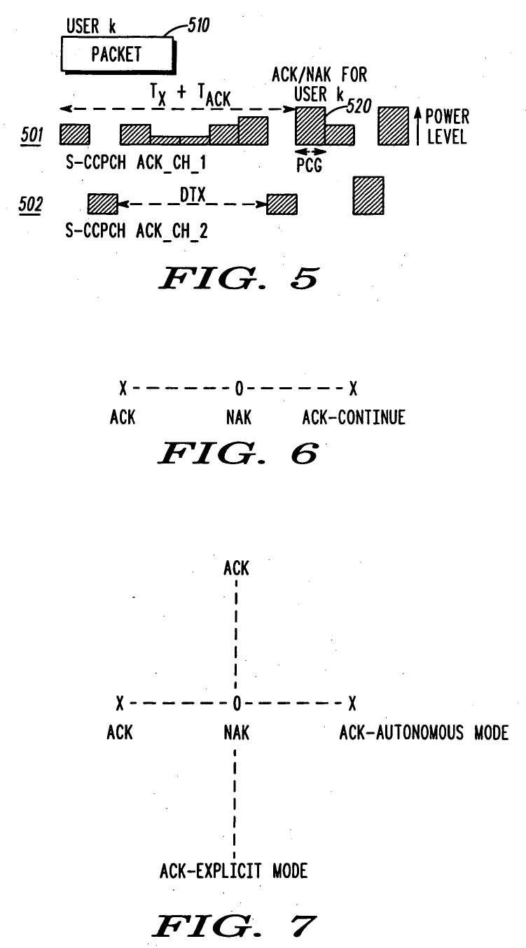

FIG. 5 is a block diagram representation of signaling on two ACK/NACK broadcast channels in accordance with multiple embodiments of the present invention. To facilitate operations in soft handover, two broadcast channels are desired. H-ARQ acknowledgement is carried on the first broadcast channel 501 (ACK_CH_1) when the received packet 510 was scheduled by this transmitting Node B, and H-ARQ acknowledgement may be carried on the second broadcast channel 502 (ACK_CH_2) when the received packet 510 was not scheduled by this Node B. Alternatively, H-ARQ acknowledgement may be carried on the first broadcast channel 501 (ACH_CH_1) when the received packet 510 comes from a non-SHO user, and H-ARQ acknowledgement may be carried on the second broadcast channel 502 (ACK_CH_2) when the received packet 510 is from a SHO user. In yet another alternative embodiment, H-ARQ acknowledgement may be carried on the first broadcast channel 501 (ACH_CH_1) when the received packet 510 was scheduled by this transmitting Node B and the user is not in SHO, and H-ARQ acknowledgement may be carried on the second broadcast channel 502 (ACK_CH_2) when the received packet 510 was not scheduled by this Node B or was scheduled by this transmitting Node B and the user is in SHO. Code channel indicators for channel 501 and 502 may be transmitted to UE in the notification message that is received by all Enhanced Uplink UE during call set-up.

As depicted in FIG. 5, only one of the broadcast channels is used for each transmission, while the other broadcast channel is DTXed. Additionally, both channels may be DTXed in the absence of ACK/NACK information to convey. Thus, in the example depicted by FIG. 5, ACK/NACK information for received packet 510 is transmitted by the scheduling Node-B as ACK/NACK signaling 520.

Since acknowledgements are transmitted to different mobiles on the same physical channel, the transmission power should be selected to ensure reliable reception by each individual UE targeted. Thus, power allocation for each transmission is dynamically determined based on the explicit power control feedback from the UE for the active or reference DPCCH, in some embodiments. Alternatively, power allocation for each transmission may be dynamically determined based on the existing Soft-Handover (SHO) measurement reports coming from the individual UE targeted. That is, instead of having explicit power control feedback from the UE, existing SHO measurement reports will be used to adjust power of the ACK/NACK channel dynamically. From a history of measurement reports the Node B can reliably estimate the power requirement at the UE targeted. Note that there is no explicit power control of the acknowledgement channels. Thus, the transmission power usually remains fixed within each slot, as depicted in FIG. 5.

The ACK/NACK signaling for an individual UE can be transmitted to that UE at a predefined offset from the beginning of the transmission. In some embodiments of the present invention, a specific color code is applied to each ACK/NACK transmission on the ACK/NACK broadcast channel. This specific codeword (or color code) addresses a particular MS, such that if the MS decodes an ACK/NACK transmission intended for another MS (i.e., having the wrong color or codeword) it will decode it as a NACK. This type of transmission identification discrimination may be enabled by specifying adequate inter-codeword distance (specified as a Hamming distance or any other, well-known information-theoretic measure) between an ACK codeword to one MS and the ACK codeword transmitted to other MS. A very simple example is to map NACK to the zero or null location of the modulation constellation (see FIGS. 6 and 7).

In other embodiments, the color coding used on the ACK/NACK broadcast channels can be determined using a hashing function. Hashing (using inputs such as a UE identifier, a frame sequence number corresponding to received UE uplink data, a cell identifier, and/or a TTI length) increases the number of color codes available without compromising the distance between codes. Thus, hashing may be necessary when there are not sufficient color codes available to assign each user its own code without compromising the distance between codes.

The idea is that both the mobile and the base station would compute the same color code via the hashing function. Therefore, at the mobile, the UE monitors the ACK/NACK broadcast channels for its color code, continuing to monitor the channels for its UE-specific ID for a specific amount of time before assuming a NACK. If at the non-scheduled base station, ACK/NACK signaling is to be sent to two mobiles which happen to have the same color code (this should be unlikely), then a collision has occurred and the non-serving base station sends nothing, i.e., effectively sends a NACK.

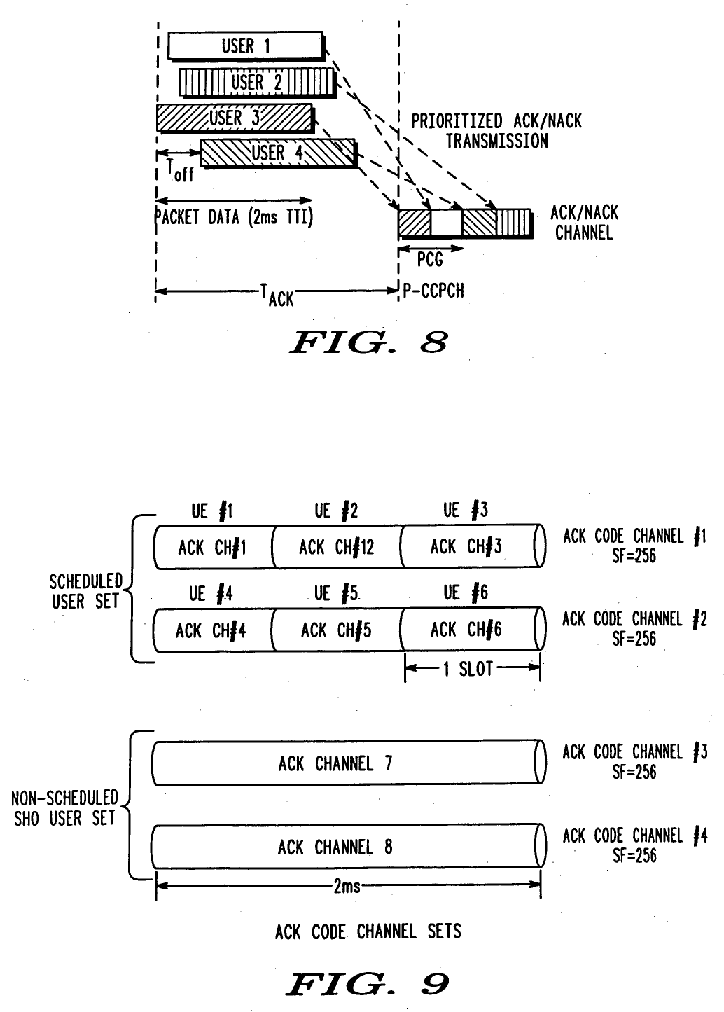

In some embodiments, each acknowledgement bit is repeated to N bits and transmitted over M power control group (PCG) or slots where the value of N is 1, 2 or 3 and M can be 0.5, 1, 2, 3, . . . . In addition, the acknowledgement channels are time aligned to the primary common control channel. For example, with 10 ms TTI, there are 15 PCG slots available to transmit the acknowledgements for the received packets for one or multiple UEs. With 2 ms TTI, however, only 3 PCG slots are available to transmit the acknowledgements for one or multiple UEs. Acknowledgement bits for each UE are repetition coded and are transmitted using a minimum of half a slot as shown in FIG. 8.

FIG. 8 is a block diagram representation of prioritized ACK/NACK signaling in accordance with multiple embodiments of the present invention. The Node-B determines a transmission priority for ACK/NACK information to be conveyed to individual UE in response to the uplink data received and schedules the ACK/NACK information onto broadcast channel time slots accordingly. For the scheduling Node B, the acknowledgement bits for different users can be prioritized using soft information from the scheduler in order to maximize data throughput. For instance, acknowledgement information for the user with the best scheduler metric may be transmitted in a descending order. FIG. 8 shows an example where ACK/NACK information for user 3 is prioritized over the other users.

For the non-scheduling Node B, acknowledgement bits for different users may be prioritized based on time of reception since the scheduler metrics are not available. One will note here that the use of two ACK/NACK broadcast channels can reduce the number of contentions.

Also, in a scenario where there are not enough time slots to transmit ACK/NACK information for all the uplink UE, the ACK/NACK information having the lower transmission priorities can be selected for non-transmission.

In some alternative embodiments, the value M and possible start times of an ACK/NAK transmission can be determined by a hashing function with inputs such as a UE identifier, a frame sequence number corresponding to received UE uplink data, a cell identifier, and/or a transmission time interval (TTI) length. This would allow a single ACK/NACK code channel to support both 2 ms and 10 ms TTI E-DCH with different M as well as addressing the non-scheduling cell problem (or even used to determine the ACK/NACK transmission interval from the scheduling cell). The idea is that both the UE and an active set cell would compute the same ACK/NACK code channel, M and possible start times via the hashing function (note that there would be a set of possible start times to give the cell flexibility). It would also allow 10 ms TTI E-DCH UE and possibly UE in poor SIR locations to have a larger M (the latter might imply that power margin is used in the hashing function or poor power margin would already be implied given a 10 ms E-DCH is being used and hence could already be accounted for in the hashing function based on TTI). Given contention for a given time interval on a given ACK/NACK code channel then only one UE would be assigned for that interval and the other UE would decode the ACK/NACK transmission as a NACK.

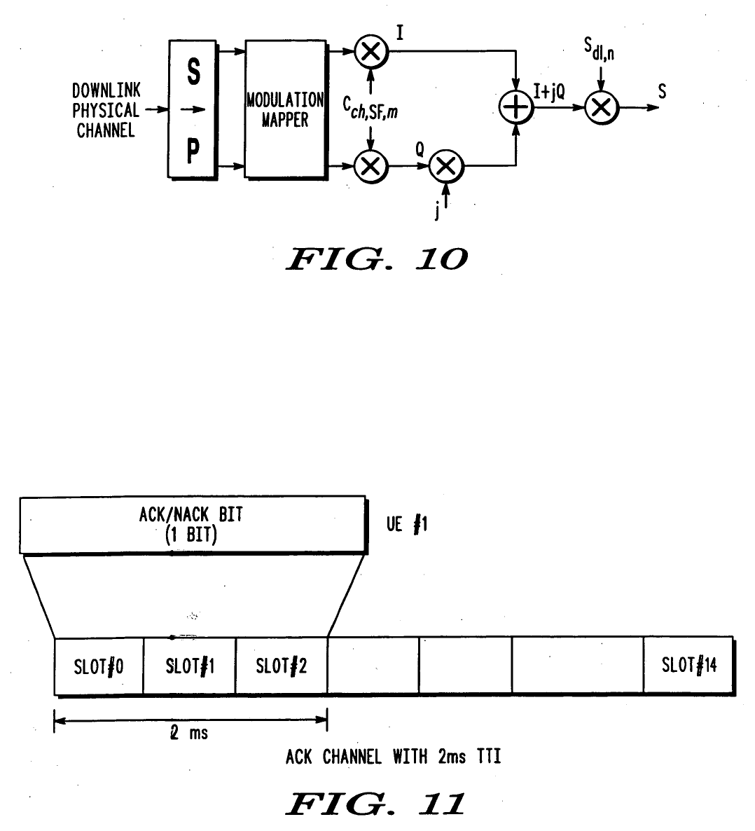

In some embodiments, the downlink control channel structure corresponding to EUL supports the ACK/NACK broadcast channels desirable for Hybrid ARQ (HARQ) and the control channels desirable for rate scheduling and time and rate scheduling. ACK/NACK code channels are assigned to two sets, one set is for non-SHO scheduled users and the other is for non-scheduled or SHO users as shown in FIG. 9. For scheduled users it is proposed that a single ACK/NACK bit be repeated 20 times followed by color coding and QPSK modulation mapping (see FIG. 10), and then spread with OVSF code of spreading factor (SF) 256 over a single slot. For non-scheduled or SHO users it is proposed that a single ACK/NACK bit be repeated 60 times followed by color coding (using the same 40-bit UE-specific mask applied to Part-1 of the HS-SCCH generated from the 16-bit HS-DSCH Radio Network Identifier (H-RNTI)), QPSK modulation mapping and then spread with OVSF code of spreading factor (SF) 256 over the three slots of a 2 ms TTI (see FIG. 11).

Given the above the processing gain can therefore be computed:
1 slot: PG=10*log10(2560)=34.0 dB
3 slot: PG=10*log10(3*2560)=38.9 dB

Given the 1% BER Eb/Nt=4.5 dB for BPSK over an AWGN channel then:
Ec/lor_{—}1slot =−29.5 dB for 0 dB Geometry=4.5−34.0−(+0))
Ec/lor_{—}3slot =−29.4 dB for −5 dB Geometry (=4.5−38.9−(−5))

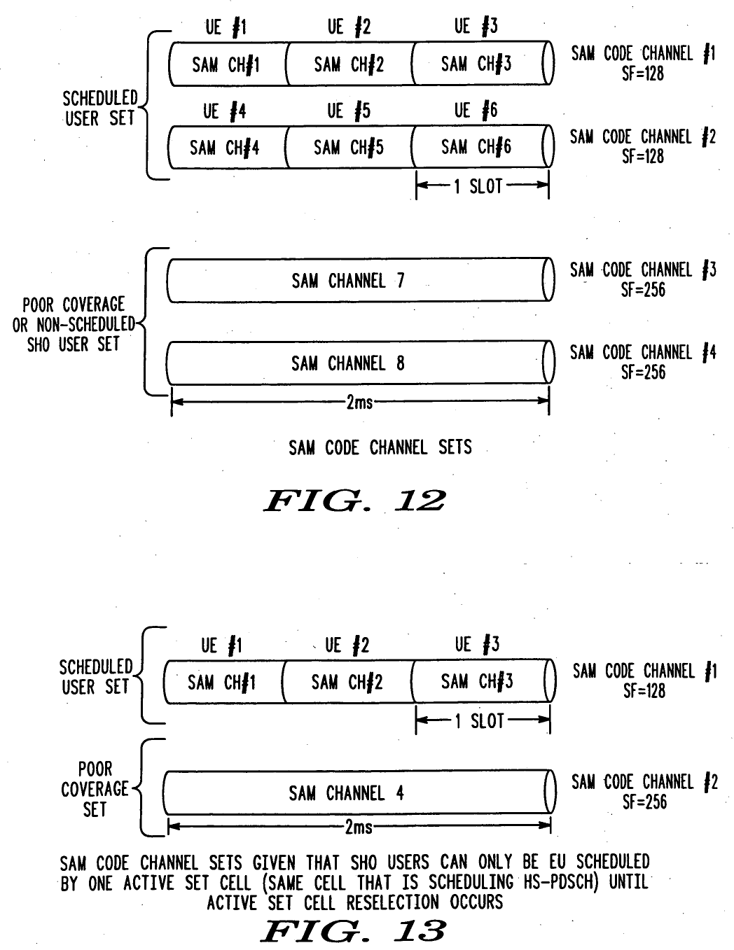

In some embodiments, a timing guard band is needed for the set of ACK channels carried on the ACK code channel used to support SHO users (or non-scheduled users and SHO users) in order to account for differences in start time for users that are in SHO compared to user that are not in SHO. Also, in some embodiments, a timing guard band is needed for the set of SAM channels carried on the SAM code channel used to support SHO users (or non-scheduled users and SHO users) in order to account for differences in start time for users that are in SHO compared to user that are not in SHO. Referring now to FIGS. 12-15, the SAM may be used to schedule the starting time of an individual UE's E-DPDCH (or DPDCH) transmission and indicate the maximum allowed power margin (or maximum TFC). A unique UE ID is used for color coding each SAM channel to allow a user to detect its assigned SAM channel.

In some embodiments, convolutional coding, color coding and OVSF coding with spreading factor (SF) of 128 or 256 is used for the SAM channel with 1 and 3 slot TTI. This allows significant reliability with low power operation and efficient code space utilization. The start time of the SAM channel is time aligned with the start time of the HS-SCCH. For scheduled users it is proposed that 8 information bits and 12 CRC bits be mapped to 40 binary symbols using Rate=1/2 convolutional coding followed by color coding (using the same 40-bit UE-specific mask applied to Part-1 of the HS-SCCH generated from the 16-bit HS-DSCH Radio Network Identifier (H-RNTI)) and then spread with a SF=128 OVSF code over a single slot. For non-scheduled SHO users it is proposed that 8 information bits, 6 tail and 16 CRC bits are R=1/3 convolutional encoded and rate matched to 60 binary symbols are modulation mapped with the CRC masked with the 16-bit H-RNTI (color coding). The symbols are then spread with a SF=256 OVSF code over the three slots of a 2 ms TTI.

Note that if a New Data Expected indicator is included in the SAM then ACK/NACK reliability can be improved given consecutive scheduling of a UE by the Node-B. Note also that the number of ACK channels requiring detection by the UE can be reduced by including an ACK code channel indicator in the SAM.

Given the above, the processing gain can therefore be computed:
1 slot: PG=10*log10(2560/8)=25.1 dB
3 slot: PG=10*log((3*2560)/8)=29.2 dB

Given the 0.1% BER Eb/Nt=4.0 dB for an AWGN channel then:
Ec/lor_{—}1slot =−21.1 dB for 0 dB Geometry (=4.0−25.1−(+0))
Ec/lor_{—}3slot =−20.8 dB for −5 dB Geometry (=4.0−29.8−(−5))

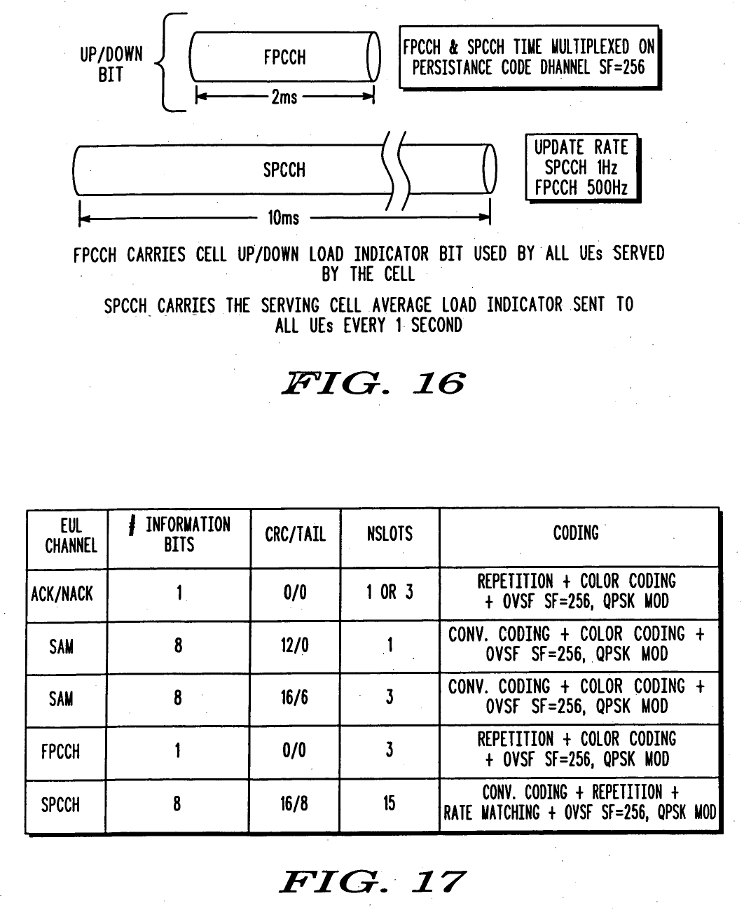

In some embodiments, depending on the rate scheduling approach used, two downlink control channels (besides the ACK channel) are used. As depicted in FIG. 16, a Fast Persistence common control channel (FPCCH) carries a single (global) up/down bit based on instantaneous RoT cell measurements. The up/down persistence bit is sent to all UE served by the cell every 2 ms in order to control RoT variation. (Note the same up/down bit is used by all UE). A Slow Persistence common control channel (SPCCH) updates all UE with the serving cell's average load status (8-bits) once per second (1 Hz update rate) such that each UE adjusts its allotted RoT margin thus controlling its transmitted data rate.

On the FPCCH, a single up/down bit is repeated 60 times followed by modulation mapping and then spread with OVSF code of spreading factor (SF) 256 over the three slots of a 2 ms TTI. Therefore, the processing gain can be computed:
PG=10*log10(3*2560)=38.9 dB
Given the 1% BER Eb/Nt=4.5 dB for BPSK over an AWGN channel then:
Ec/lor FPCCH=−29.4 dB for −5 dB Geometry (=4.5−38.9−(−5))

On the SPCCH, an 8-bit cell load indicator, 16-bit CRC, and 8-bit tail are R=1/3 convolutional encoded and rate matched to 300 binary symbols, QPSK modulation mapped and then spread with a SF=256 OVSF code over fifteen slots of a 10 ms TTI. Note that the SPCCH is time multiplexed on the same persistence code channel as the FPCCH Channel without system impact since the SPCCH transmission is only sent once per second.

Given the above, the processing gain can therefore be computed:
PG=10*log10(38400/8)=36.8 dB

Given the 0.1% BER Eb/Nt=4.0 dB for an AWGN channel then:
Ec/lor SPCCH=−27.8 dB for −5 dB Geometry (=4.0−36.8−(−5))

The ACK and SAM Channel time slots are time aligned with the HS-SCCH and HS-PDSCH. The case of ACK and SAM Channels with 3 slot TTI are time aligned with HS-SCCH and HS-PDSCH 2 ms sub-frames. It is assumed that the E-DPCH will be time aligned with the HS-DPCCH and that the UE (and Node-B) will use the same m timing offset parameter set as described in Section 7.7 of TS 25.211-530. Each time a different active set cell is selected as the HSDPA scheduling cell the m offset set will be calculated to reflect the reconfiguration of a new HSDPA (and EU) serving cell. The resulting enhanced uplink timing equations assuming N=5 Stop and Wait HARQ are:

$${T}_{SAM} = {T}_{PCCPCH , cfn} + ( i + 3 ) * 2560 * 3 - 5 * 3 * 2560$$

$${T}_{ACK} = {T}_{EDPCH , cell} - 5 * 3 * 2560 + 8.5 * 2560 \\ = {T}_{PCCPCH , cfn} + ( i + 3 ) * 2560 * 3$$

$${T}_{EDPCH , ue} = {T}_{ULDPCH , cfn , ue} + m * 256 + i * 3 * 2560$$

$${T}_{EDPCH , ue} = {T}_{SAM} + 6.5 * 2560 + tp + 5 * 3 * 2560$$

$${T}_{EDPCH , cell} = {T}_{ULDPCH , cfn} + m * 256 + tp + i * 3 * 2560$$

$$\text{(arrival start time at cell)} \\ = {T}_{PCCPCH , cfn , cell1} + FCo , \\ cell1 + To + m * 256 + tp + i * 3 * 2560 \\ = {T}_{PCCPCH , cfn , cell2} + FCo , \\ cell2 + To + m * 256 + tp + i * 3 * 2560$$

where
i represents EU HARQ channel in the range from 0 to N-1,
FCo,cellx is the frame+chip offset at cellx for a given UE,
m timing offset used by a UE for determining the HS-DPCCH start time relative to UL DPCH, AND
T_{UETX}=T_{ULDPCH,cfn}—time when a UE transmits an UL DPCH for a given cfn.

Note that it is still possible for active cells other than the HSDPA serving cell to schedule the E-DPCH where such cells will use the same ‘m’ as the HSDPA serving cell. The value of ‘m’ is only calculated by the reconfiguration procedure via higher layer signaling. Hence, there is no modification in the timing relation between HS-DPCCH and UL-DPCH throughout the downlink radio link (of an active set cell) tracking process. The value of ‘m’ is derived based on the DPCH frame timing offset, assuming that the UE centers the RX window around the DPCH from the HS-DSCH serving cell. The timing is defined relative to the UL DPCH frame start belonging to the DL DPCH frame that contains the start of the related HS-DSCH subframe.

The Hybrid ARQ function requires that a positive or negative acknowledgement (ACK or NACK) be sent to UE via an ACK channel after each E-DPDCH (or DPDCH) uplink transmission. Based on enhanced uplink system simulation results, it was determined that the maximum number of users needed per time and rate scheduled TTI is six, or in other words, six is the maximum CDM required per E-DPDCH (or DPDCH) TTI to achieve 99% of the maximum possible throughput. For rate scheduling the required maximum CDM is ten to achieve 99% of the maximum possible throughput.

Given Soft handoff is not supported for the E-DPDCH then two ACK code channels with one slot user ACK channels (TDM=3) are adequate to support the maximum CDM requirement per time and rate scheduled TTI. For rate scheduling four ACK code channels are required. Given color coding based on a unique UE ID, then a UE would decode each ACK channel and choose the one with the highest correlation energy and compare to a threshold to determine if an ACK or NACK was sent for it. In the case of time and rate scheduling a UE would have to decode six one slot user ACK channels (12 in the case of rate scheduling) after each E-DPDCH (or DPOCH) transmission. However, in the time and rate case, the number of ACK channels to be decoded can be reduced by sending an ACK code channel indicator via a scheduling assignment message (SAM). The SAM is used to schedule the starting time of a UE's E-DPDCH (or DPDCH) transmission and indicate the maximum allowed power margin.

If Soft handoff is supported for the E-DPDCH (or DPDCH) then more ACK code channels are needed to support both the maximum CDM requirement and to support SHO users not scheduled by the Node-B to reduce ACK channel contention. In order to achieve required coverage for SHO users the option of having three slot user ACK channels is considered desirable. It is possible to partition the ACK channels between scheduled users and non-scheduled SHO users such that scheduled users can be assigned any of the ACK channels in the set for scheduled users while non-scheduled SHO users are only assigned ACK channels in the non-scheduled SHO user ACK channel set. It may be desirable to allow the scheduled users to be assigned any of the ACK channels in either set for trunking efficiency reasons.

Given fully synchronous HARQ is used then a UE once scheduled must keep transmitting the packet on the chosen or assigned HARQ channel until it decodes an ACK or the maximum number of transmissions is reached. However, the SAM only needs to be transmitted once to start the transmission and potential re-transmissions of a given packet by a UE. For added reliability the SAM is also transmitted along with the NACK sent on the ACK channel before the first retransmission. If the UE does not detect the SAM on the re-transmission then it assumes that it erroneously detected the first SAM and discontinues transmitting the packet. This avoids the UE from transmitting all MAXRETRY (e.g., 4) transmissions. This may not be any different from another active set cell scheduling the UE instead of the cell in question. Hence, if false alarms occur then the active set cells should treat the UE as being scheduled by another active set cell and therefore try to decode the frames and send ACKs.

The difference between partially asynchronous and fully synchronous HARQ is that the SAM would be sent before every transmission instead of just at the first transmission of a packet. Also with partially asynchronous HARQ the scheduler retains more flexibility since it can send retransmissions at a later time. By sending the SAM before every transmission the effects of certain false alarm error conditions are minimized. For example, with fully asynchronous HARQ when a UE falsely detects a SAM it would then transmit MAXRETRY times before halting. With partially asynchronous HARQ this would not happen. On the other hand some retransmissions would not occur with partially asynchronous HARQ due to missed detections or detection failures of the SAM. One way to mitigate the fully synchronous false detection problem is to treat it like the transmission of a non-scheduled SHO user which in order to support SHO needs to be detected and decoded anyway for achieving a macro-selection diversity benefit.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention. In addition, those of ordinary skill in the art will appreciate that the elements in the drawings are illustrated for simplicity and clarity, and have not necessarily been drawn to scale. For example, the dimensions of some of the elements in the drawings may be exaggerated relative to other elements to help improve an understanding of the various embodiments of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

1. A method for ACK/NACK signaling to facilitate uplink data transfer by user equipment (UE) in a wireless communication system, the method comprising:
transmitting, by a Node-B, code channel indicators for a first ACK/NACK broadcast channel and for a second ACK/NACK broadcast channel;
determining a transmission priority for ACK/NACK information to be conveyed to individual UE in response to uplink data received from the UE;
scheduling the ACK/NACK information onto ACK/NACK broadcast channel time slots according to the transmission priority determined;
transmitting, by the Node-B, ACK/NACK signaling to convey the scheduled ACK/NACK information via either the first ACK/NACK broadcast channel or the second ACK/NACK broadcast channel.

2. The method of claim 1, wherein transmitting the ACK/NACK signaling via either broadcast channel comprises transmitting the ACK/NACK signaling via the first ACK/NACK broadcast channel when the received uplink data was scheduled by the Node-B.

3. The method of claim 1, wherein transmitting the ACK/NACK signaling via either broadcast channel comprises transmitting the ACK/NACK signaling via the first ACK/NACK broadcast channel when the UE is not in soft-handoff.

4. The method of claim 1, wherein transmitting the ACK/NACK signaling via either broadcast channel comprises transmitting the ACK/NACK signaling via the first ACK/NACK broadcast channel when the received uplink data was scheduled by the Node-B and when the UE is not in soft-handoff.

5. The method of claim 1, wherein transmitting the ACK/NACK signaling via either broadcast channel comprises transmitting the ACK/NACK signaling via the second ACK/NACK broadcast channel when the received uplink data was not scheduled by the Node-B.

6. The method of claim 1, wherein transmitting the ACK/NACK signaling via either broadcast channel comprises transmitting the ACK/NACK signaling via the second ACK/NACK broadcast channel when the UE is in soft-handoff.

7. The method of claim 1, wherein transmitting the ACK/NACK signaling via either broadcast channel comprises transmitting the ACK/NACK signaling via the second ACK/NACK broadcast channel when the received uplink data was not scheduled by the Node-B and when the UE is in soft-handoff.

8. The method of claim 1, wherein the ACK/NACK signaling comprises H-ARQ acknowledgement signaling.

9. The method of claim 1, wherein transmitting the code channel indicators comprises transmitting the code channel indicators to uplink UE via a notification message transmitted during UE call setup.

10. The method of claim 1, wherein determining a transmission priority for ACK/NACK information to be conveyed to individual UE comprises determining a higher priority for ACK/NACK information that corresponds to earlier received uplink data.

11. The method of claim 1, wherein determining a transmission priority for ACK/NACK information to be conveyed to individual UE comprises determining a higher priority for ACK/NACK information that corresponds to UE with a higher scheduler metric.

12. The method of claim 1, wherein scheduling the ACK/NACK information onto ACK/NACK broadcast channel time slots according to the transmission priority determined comprises, when the time slots are full, selecting ACK/NACK information having lower transmission priority than the ACK/NACK information already scheduled in the time slots to not be transmitted.

13. The method of claim 1, wherein transmitting ACK/NACK signaling comprises color coding the ACK/NACK information for each individual UE targeted.

14. The method of claim 13, wherein color coding the ACK/NACK information comprises color coding the ACK/NACK information for each individual UE such that UE other than targeted UE decode the ACK/NACK signaling as a NACK.

15. The method of claim 13, wherein color coding the ACK/NACK information for each individual UE comprises determining a color code for each individual UE using a hashing function.

16. The method of claim 15, wherein the hashing function has at least one input from the group consisting of a UE identifier, a frame sequence number corresponding to received UE uplink data, a cell identifier, and a transmission time interval (TTI) length.

17. The method of claim 1, wherein transmitting ACK/NACK signaling via the first ACK/NACK broadcast channel comprises concurrently transmitting DTX (discontinuous transmission) signaling via the second ACK/NACK broadcast channel and wherein transmitting ACK/NACK signaling via the second ACK/NACK broadcast channel comprises concurrently transmitting DTX signaling via the first ACK/NACK broadcast channel.

18. The method of claim 1, wherein transmitting ACK/NACK signaling comprises determining a transmit power for the ACK/NACK signaling for each individual UE targeted.

19. The method of claim 18, wherein determining a transmit power for the ACK/NACK signaling for each individual UE comprises determining a transmit power based on power control signaling, from the individual UE targeted, for a Dedicated Physical Control Channel (DPCCH) of the UE targeted.

20. The method of claim 18, wherein determining a transmit power for the ACK/NACK signaling for each individual UE comprises determining a transmit power based on recent soft handover measurement reports from the individual UE targeted.

21. The method of claim 1, wherein transmitting ACK/NACK signaling comprises repeating each acknowledgement bit to N bits transmitted over M PCG slots, wherein N is 1, 2 or 3 and M is 0.5, 1, 2, 3, or . . . .

22. The method of claim 21, wherein transmitting ACK/NACK signaling comprises determining, using a hashing function, M and a transmission start time for ACK/NACK signaling of an individual UE.

23. The method of claim 22, wherein the hashing function has at least one input from the group consisting of a UE identifier, a frame sequence number corresponding to received UE uplink data, a cell identifier, a power margin, and a transmission time interval (TTI) length.

24. A method for ACK/NACK signaling to facilitate uplink data transfer by user equipment (UE) in a wireless communication system, the method comprising:
receiving, by UE, code channel indicators for a first ACK/NACK broadcast channel and for a second ACK/NACK broadcast channel;
transmitting, by UE, uplink data;
monitoring, by UE, ACK/NACK signaling for a color code of the UE, wherein the first ACK/NACK broadcast channel is monitored for ACK/NACK signaling in response to the uplink data transmission from a scheduling Node-B and the second ACK/NACK broadcast channel is monitored for ACK/NACK signaling in response to the uplink data transmission from a non-scheduling Node-B.

25. The method of claim 24, further comprises determining, by the UE, the color code of the UE using a hashing function, wherein the hashing function has at least one input from the group consisting of a UE identifier, a frame sequence number corresponding to the uplink data, a cell identifier, and a transmission time interval (TTI) length.
